(19) United States
(12) Patent Application Publication
(10) Pub. No.: US 2023/0040133 A1
(43) Pub. Date: Feb. 9, 2023

(54) WORK SEQUENCE GENERATION APPARATUS AND WORK SEQUENCE GENERATION METHOD

(71) Applicant: Hitachi, Ltd., Tokyo (JP)

(72) Inventors: Toshiko AIZONO, Tokyo (JP); Fumiya KUDO, Tokyo (JP); Yuya OKADOME, Tokyo (JP)

(21) Appl. No.: 17/690,273

(22) Filed: Mar. 9, 2022

(30) Foreign Application Priority Data
Aug. 5, 2021 (JP) 2021-128881

(51) Int. Cl. G06Q 10/06

(52) U.S. Cl. CPC G06Q 10/06316; G06Q 10/06393

(57) ABSTRACT

To provide a work sequence capable of suppressing reduction of an evaluation value within an allowable range. A work sequence generation apparatus including a processor that executes a program and a storage device that stores therein the program, and generating a work sequence specifying an order of working on a processing object group performs a perturbation process of generating a second work sequence by perturbating a first work sequence, and a learning process of generating a learning model for generating a specific work sequence so that a difference from an evaluation value regarding a work in an input work sequence is within an allowable range by learning that a difference between a first evaluation value regarding a work in the first work sequence and a second evaluation value regarding a work in a second work sequence generated in the perturbation process should be within the allowable range.

### CLAIM OF PRIORITY

The present application claims priority from Japanese patent application JP 2021-128881 filed on Aug. 5, 2021, the content of which is hereby incorporated by reference into this application.

### TECHNICAL FIELD

The present invention relates to a work sequence generation apparatus that generates a work sequence and a work sequence generation method.

### BACKGROUND ART

In a distribution warehouse or a production facility (hereinbelow, “field”), a sequential order in which an ordered product is worked on significantly effects KPIs (Key Performance Indicators) such as productivity and cost. Therefore, a field manager attempts to achieve or improve a KPI by generating the work order manually or using some tool on the basis of knowledge from the past and result data.

Patent Literature 1 discloses a plan generation apparatus that generates a robust plan within a practical time period. The plan generation apparatus is a plan generation apparatus 1 that generates a required schedule including a plurality of specific work elements selected from a plurality of work elements, the plan generation apparatus 1 including: a work element information acquisition unit that acquires an index indicative of a degree of variation in required time for the plurality of work elements and for each of the work elements; a variation scenario generation unit that generates a variation scenario specifying the required time for each of the work elements on the basis of the index indicative of the degree of variation in the required time; a required schedule specifying unit that specifies a plurality of required schedules on the basis of the variation scenario; and a determination unit that specifies a specific required schedule from the plurality of required schedules.

### CITATION LIST

### Patent Literature

Patent Literature 1: Japanese Unexamined Patent Application Publication No. 2018-165952

### SUMMARY OF INVENTION

### Technical Problem

By changing the work order that maximizes the KPI, the KPI may be degraded in the work order after the change. On the other hand, many workers are working in the field using various instruments and facilities, and the work order may be changed under various conditions as described below. In such cases, the KPI may be degraded and become problematic.

Variation in the skill of workers (i.e., new worker and experienced worker).
Sudden deficiency and excess of the number of products to be worked on and workers, sudden failure of an instrument/facility.
Intentional change of work order by a worker or a supervisor (i.e., changing the work order as convenient under the facing condition).

Moreover, proximity to an optimal solution generated by a mathematical optimization technique may not always be the best solution. Thus, there is a risk of not achieving the KIP or degrading the KIP if the work order is partially altered at the time of execution. To solve this problem, it is necessary to exhaustively formulate a restriction including a condition under which the work is not executed as planned; however, as described above, there is a variety of conditions, and it is difficult to cope with them. Moreover, the mathematical optimization technique may take some time to generate an optimal solution. This may become a problem when quick determination of the work order is a business requirement.

It is an object of the present invention to provide a work sequence capable of suppressing reduction of an evaluation value within an allowable range even if the sequential order is changed during work.

### Solution to Problem

A work sequence generation apparatus according to an aspect of the invention disclosed herein is a work sequence generation apparatus including a processor that executes a program and a storage device that stores therein the program and generating a work sequence specifying an order of working on a processing object group, in which the processor performs a perturbation process of generating a second work sequence by perturbating a first work sequence, and a learning process of generating a learning model for generating a specific work sequence so that a difference from an evaluation value regarding a work in an input work sequence is within an allowable range by learning that a difference between a first evaluation value regarding a work in the first work sequence and a second evaluation value regarding a work in a second work sequence generated in the perturbation process should be within the allowable range.

A work sequence generation apparatus according to another aspect of the invention disclosed herein is a work sequence generation apparatus including a processor that executes a program and a storage device that stores therein the program, and generating a work sequence specifying an order of working on a processing object group, in which the processor performs a perturbation process of generating a second work sequence by perturbating a first work sequence, a calculation process of calculating a rank correlation coefficient between the first work sequence and the second work sequence, and a determination process of determining the second work sequence to be an output target on the basis of a comparison result between a lower-limit evaluation value based on a first evaluation value regarding a work in the first work sequence and a second evaluation value regarding a work in the second work sequence, and a number of third work sequences that is the rank correlation coefficient calculated in the calculation process.

### Advantageous Effects of Invention

According to a representative implementation of the present invention, it is possible to provide a work sequence capable of suppressing reduction of an evaluation value within an allowable range even if the sequential order is changed during work. Problems, configurations, and effects other than those described above will become apparent from the following description of embodiments.

### BRIEF DESCRIPTION OF DRAWINGS

FIG. 1 is an explanatory diagram showing an example sorting work in a distribution warehouse;

FIG. 2 is a block diagram showing an example hardware configuration of a work sequence generation apparatus;

FIG. 3 is a block diagram showing an example functional configuration of the work sequence generation apparatus according to a first embodiment;

FIG. 4 is an explanatory diagram showing an example of an order list group;

FIG. 5 is an explanatory diagram showing an example of a commodity master;

FIG. 6 is an explanatory diagram showing an example of a plan data group;

FIG. 7 is an explanatory diagram showing an example of a result data group;

FIG. 8 is an explanatory diagram showing an example perturbation generation by a perturbation generation unit;

FIG. 9 is an explanatory diagram showing an example evaluation by an evaluation unit;

FIG. 10 is an explanatory diagram showing an example work sequence model learning by a work sequence generation model learning unit;

FIG. 11 is a block diagram showing an example functional configuration of a work sequence generation apparatus according to a second embodiment;

FIG. 12 is a flowchart showing an example work sequence generation procedure by the work sequence generation apparatus according to the second embodiment;

FIG. 13 is an explanatory diagram showing an example statistic work order model generation and an example perturbation generation;

FIG. 14 is an explanatory diagram showing an example calculation of a rank correlation by adequacy evaluation;

FIG. 15 is an explanatory diagram showing an example adequacy evaluation by the adequacy evaluation;

FIG. 16 is an explanatory diagram showing a first example display screen of the work sequence generation apparatus;

FIG. 17 is an explanatory diagram showing a second example display screen of the work sequence generation apparatus;

FIG. 18 is an explanatory diagram showing a first example progress screen of the work sequence generation apparatus;

FIG. 19 is an explanatory diagram showing a second example progress screen of the work sequence generation apparatus; and

FIG. 20 is an explanatory diagram showing a third example progress screen of the work sequence generation apparatus.

### DESCRIPTION OF EMBODIMENTS

### First Embodiment

### Example Sorting Work in Distribution Warehouse

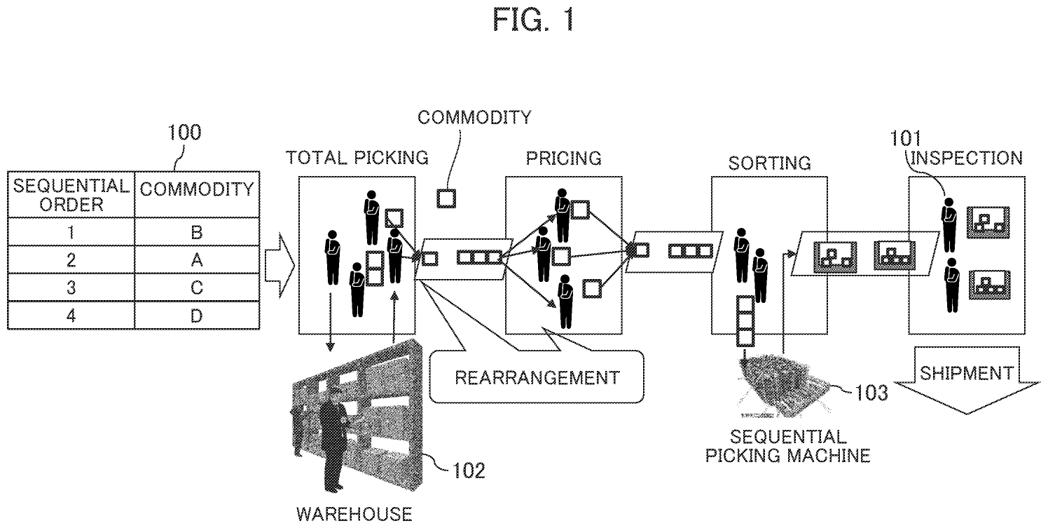

FIG. 1 is an explanatory diagram showing an example sorting work in a distribution warehouse. The sorting work in the distribution warehouse is performed in the order of a total picking process, a pricing process, a sorting process, and an inspection process. In the total picking process, a worker 101 picks up a commodity as a processing object from a warehouse in accordance with a work sequence 100. In the pricing process, the worker 101 applies a price sticker to the commodity picked up in the total picking. In the sorting process, the worker 101 sorts the priced commodity by its destination using a sequential picking machine 103. In the inspection process, the worker 101 inspects and ships the commodity sorted by destination.

In the total picking process and the pricing process, the work sequence 100 may be altered and the sorting process may not be completed within expected work time. For example, although the work sequence 100 is specified in the order of commodities B, A, C, and D, the order of picking the commodities may be altered on the basis of difference in skills of the worker 101 in the total picking process, or the sequence in the pricing process may be altered to C→B in the field decision because it is easier to price the commodity C after the commodity B. The work sequence generation apparatus according to the first embodiment reduces degradation of the KPI of the work order after alteration, even in the event of such an alteration of the work sequence 100.

### Example Hardware Configuration of Work Sequence Generation Apparatus

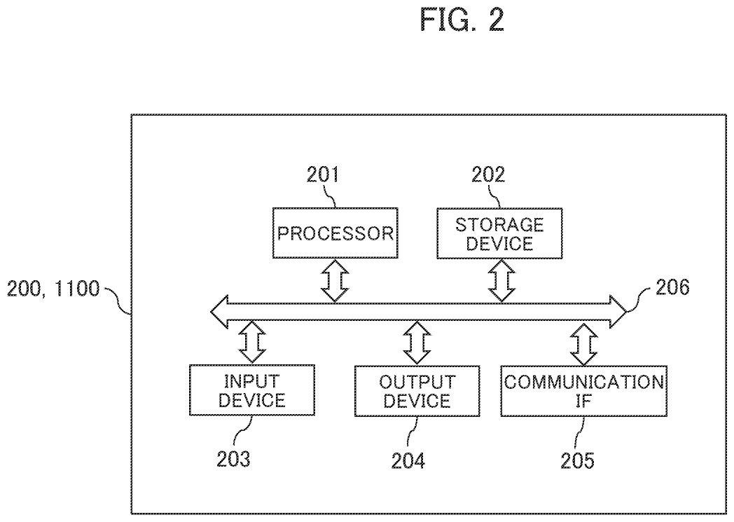

FIG. 2 is a block diagram showing an example hardware configuration of the work sequence generation apparatus. The work sequence generation apparatus 200 includes a processor 201, a storage device 202, an input device 203, an output device 204, and a communication interface (communication IF) 205. The processor 201, the storage device 202, the input device 203, the output device 204, and the communication IF 205 are connected by a bus 206. The processor 201 controls the work sequence generation apparatus 200. The storage device 202 is a working area of the processor 201. Moreover, the storage device 202 is a non-transitory or transitory recording medium that stores therein various programs and data. The storage device 202 includes, for example, a ROM (Read Only Memory), a RAM (Random Access Memory), an HDD (Hard Disk Drive), and a flash memory. The input device 203 inputs data. The input device 203 includes, for example, a keyboard, a mouse, a touch panel, a numeric keypad, a scanner, a microphone, and a sensor. The output device 204 outputs data. The output device 204 includes, for example a display, a printer, and a speaker. The communication IF 205 connects to a network and transmits/receives data.

### Example Functional Configuration of Work Sequence Generation Apparatus

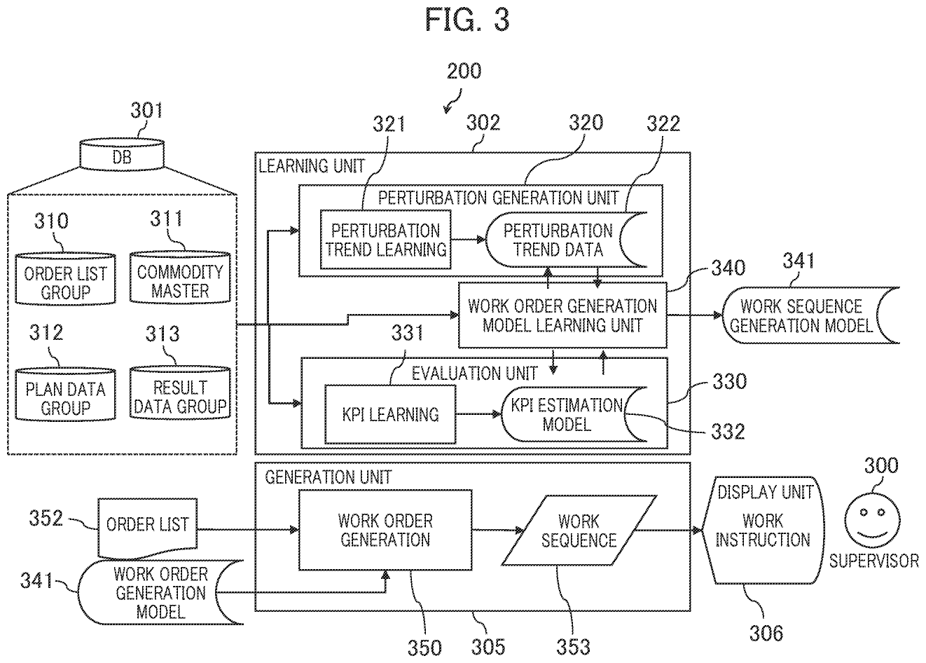

FIG. 3 is a block diagram showing an example functional configuration of the work sequence generation apparatus according to the first embodiment. The work sequence generation apparatus 200 includes a database (DB) 301, a learning unit 302, a generation unit 305, and a display unit 306. The DB 301 is specifically embodied by, for example, the storage device 202 shown in FIG. 2 or any other computer communicable to the work sequence generation apparatus 200 via the communication IF 205. The learning unit 302 and the generation unit 305 are specifically embodied by, for example, having the processor 201 execute the program stored in the storage device 202 shown in FIG. 2. The display unit 306 is specifically embodied by, for example, the output device 204 shown in FIG. 2 or any other computer communicable to the work sequence generation apparatus 200 via the communication IF 205.

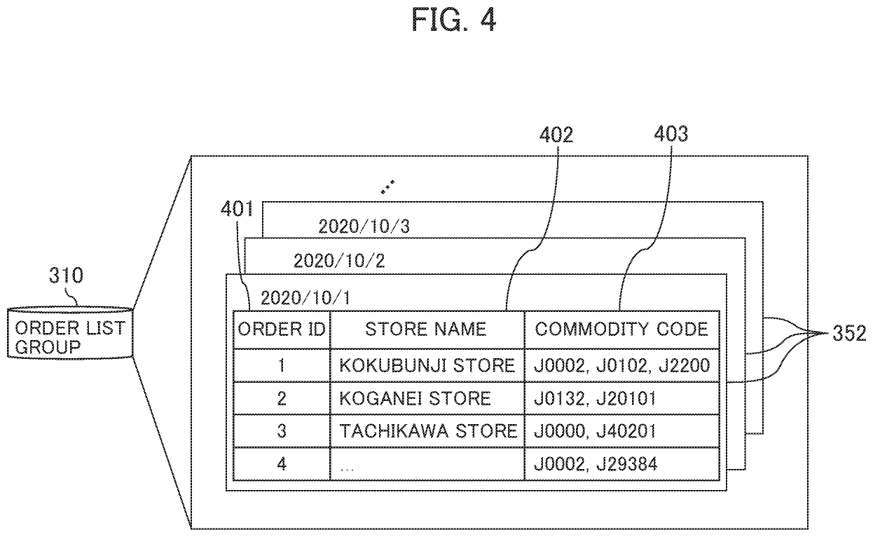

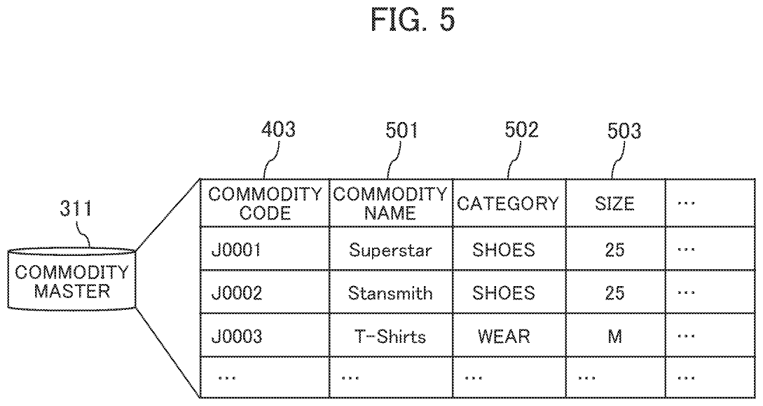

The DB 301 contains an order list group 310, a commodity master 311, a plan data group 312, and a result data group 313. The order list group 310 is a set of daily order lists 352, which will be described later with reference to FIG. 4. The commodity master 311 is a mater table that retains commodity attribute information of with respect to each commodity, which will be described later with reference to FIG. 5.

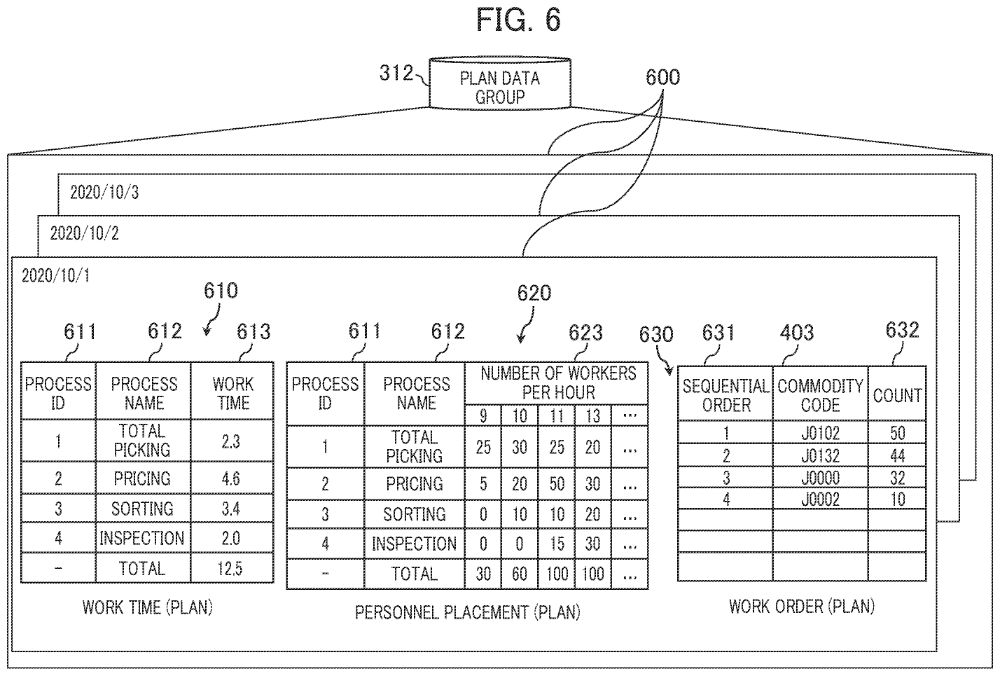

The plan data group 312 is a set of plan data for planning, with respect to the order list 352 of a certain day, scheduled work time until all the processes shown in FIG. 1 are completed and the scheduled work time for each process, how may workers 101 should be arranged for each process, and which commodity should be processed in what order, which will be described later with reference to FIG. 6.

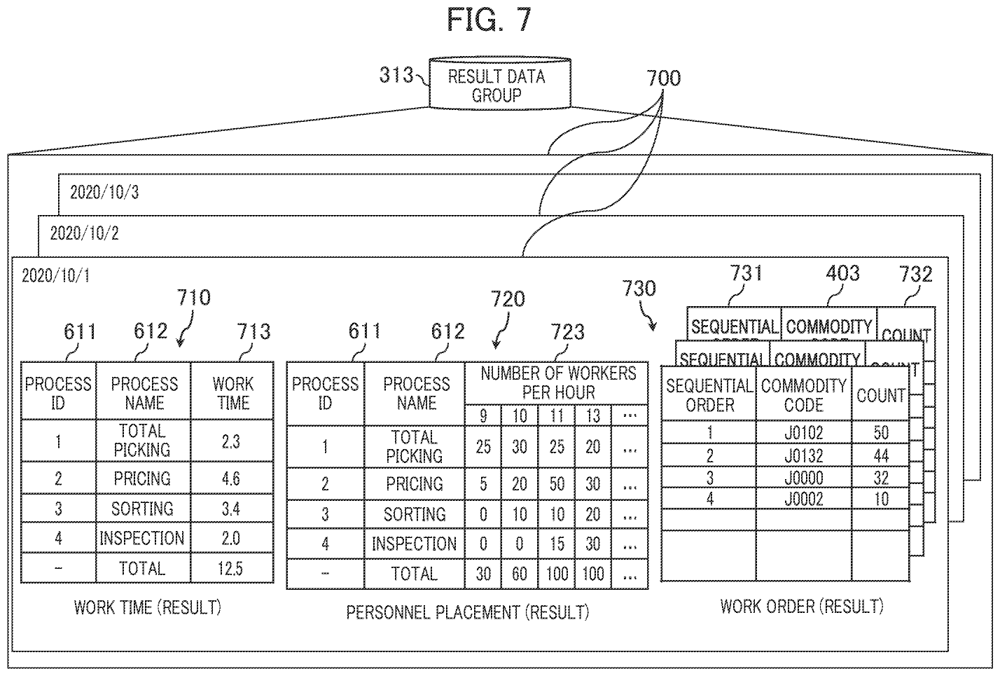

The result data group 313 is a set of result data that records, with respect to the order list 352 of a certain day, actual work time that all the processes shown in FIG. 1 have been completed and the actual work time of each process, how many workers were arranged for each process, and which commodity was processed in what order, which will be described later with reference to FIG. 7.

The learning unit 302 generates a feasible work sequence by mapping a work order included in the result data in a solution space and searching the solution space for an optimal solution. Since the sequential order may be restricted (e.g., the commodity D should not come after the commodity A) and thus a solution automatically searched for and generated may not necessarily be feasible, the learning unit 302 searches for the optimal solution by mapping the result data in the solution space with respect to each restriction.

The learning unit 302 specifically includes, for example, a perturbation generation unit 320, an evaluation unit 330, and a work sequence generation model learning unit 340.

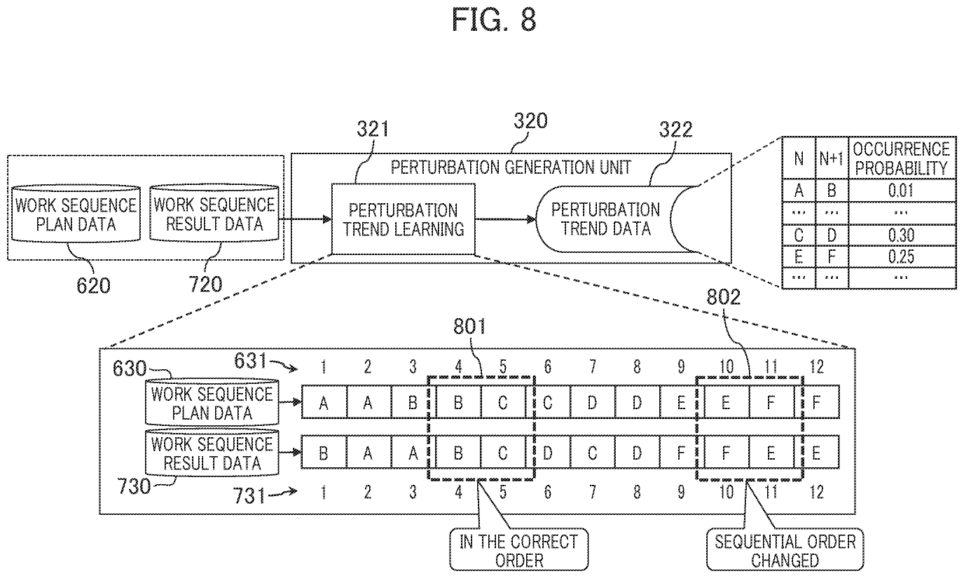

The perturbation generation unit 320 generates perturbation trend data 322 by comparing the plan data with the result data and executing perturbation trend learning 221. Specifically, for example, the perturbation generation unit 320 detects how the actual work sequence was changed with respect to the planned work sequence, and learns the detected change as the perturbation trend data 322. Details of the perturbation generation unit 320 will be described later with reference to FIG. 8.

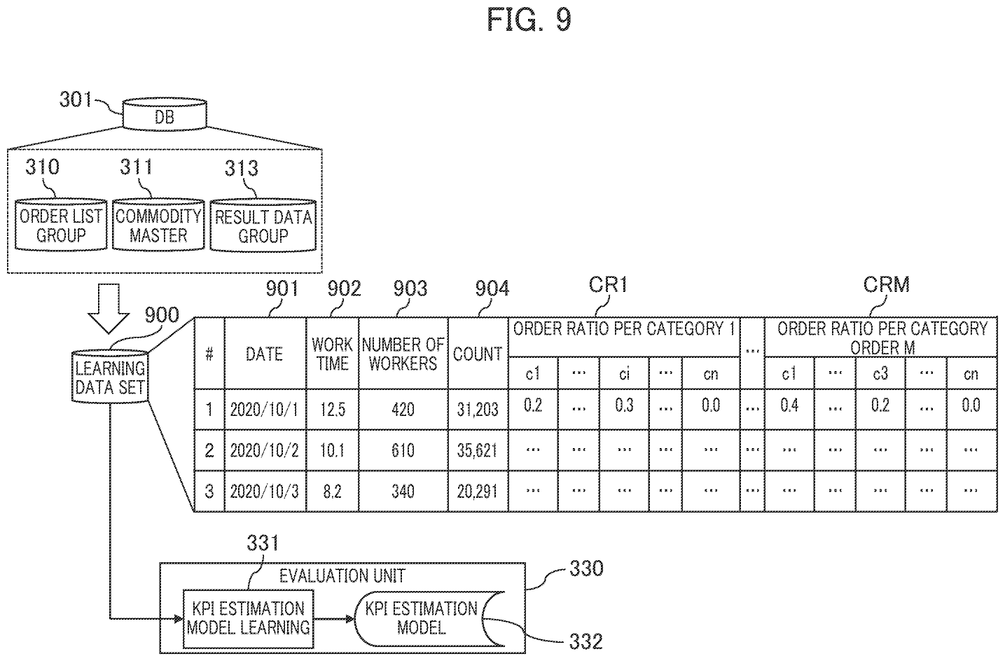

The evaluation unit 330 executes KPI learning 231 using the order list group 310, the commodity master 311, and the result data group 313, and generates a model for estimating the KPI (KPI estimation model 232). KPI is, for example, an evaluation value corresponding to the work time (which maybe the work time itself or a reciprocal of the work time), or an evaluation value corresponding to the number of workers (which may be the number of workers itself or a reciprocal of the number of workers). Details of the evaluation unit 330 will be described later with reference to FIG. 9.

The work sequence generation model learning unit 340 learns a model for generating a robust work sequence (work sequence generation model 341) using the plan data group 312 as the input. Specifically, for example, the work sequence generation model learning unit 340 searches for the work sequence, perturbates the searched work sequence using the perturbation trend data 322, and calculates the KPI of the perturbated work sequence using the KPI estimation model 232.

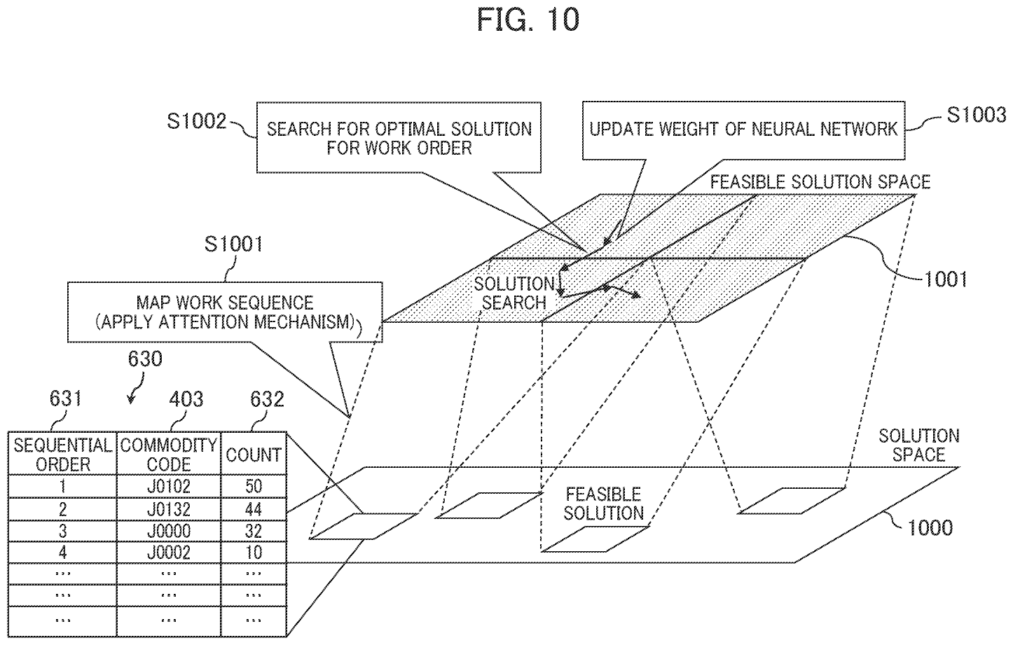

The work sequence generation model learning unit 340 then updates a weight parameter of a neural network on the basis of a difference between the calculated KPI and a target KPI, and thereby generates the work sequence generation model 341. Details of the work sequence generation model learning unit 340 will be described later with reference to FIG. 10.

Upon receiving an input that the order list 352 is acceptable from a supervisor 300, the generation unit 305 inputs the order list 352 to the work sequence generation model 341, generates the work sequence, and outputs the work sequence to the display unit 306. It should be noted that the order list 352 to be input may be included in the order list group 310 or derived from outside the order list group 310.

### Order List Group 310

FIG. 4 is an explanatory diagram showing an example of the order list group 310. The order list group 310 is a set of the daily order lists 352. Each of the order list 352 includes an order ID 401, a store name 402, and a commodity code 403. Values of the order ID 401, the store name 402, and the commodity code 403 in the same row form one order.

The order ID 401 is identification information that identifies an order in the order list 352. The store name 402 is information that identifies a name of a store that made the order, namely, an ordering party. The commodity code 403 is identification information that identifies a commodity in the order. It should be noted that the commodity code 403 may include the count of the commodity in the order.

### Commodity Master 311

FIG. 5 is an explanatory diagram showing an example of the commodity master 311. The commodity master 311 includes as the commodity attribute information, for example, the commodity code 403, a commodity name 501, a category 502, and a size 503. The commodity name 501 is a name of the commodity identified by its commodity code 403. The category 502 is classification information indicative of a category of the commodity. The size 503 indicates the size of the commodity.

### Plan Data Group 312

FIG. 6 is an explanatory diagram showing an example of the plan data group 312. The plan data group 312 is a set of daily plan data 600. The plan data 600 is generated on the basis of the order list 352 of the day or earlier.

The plan data 600 includes work time plan data 610, personnel placement plan data 620, and work sequence plan data 630. The work time plan data 610 is plan data regarding the work time with respect to each process shown in FIG. 1. Specifically, for example, the work time plan data 610 includes a process ID 611, a process name 612, and work time 613. The process ID 611 is identification information that uniquely identifies the process shown in FIG. 1. The process name 612 is a name of the process shown in FIG. 1. The work time 613 indicates time taken to work in the process identified by the process ID and the process name.

The personnel placement plan data 620 is plan data regarding arrangement of the workers 101 with respect to each process shown in FIG. 1. Specifically, for example, the personnel placement plan data 620 includes the process ID 611, the process name 612, and a number of workers per hour 623. The number of workers per hour 623 indicates the planned number of the workers required for each process per unit time (e.g., per hour).

The work sequence plan data 630 is data for planning the work sequence for the commodity. Specifically, for example, the work sequence plan data 630 includes a sequential order 631, the commodity code 403, and a count 632. The sequential order 631 indicates an ascending numerical order in the work order of the commodity. The count 632 indicates the planned number of the commodities identified by the commodity code 403 to be processed in the sequential order 631.

### Result Data Group 313

FIG. 7 is an explanatory diagram showing an example of the result data group 313. The result data group 313 is a set of daily result data 700. The result data 700 is an actual measurement value acquired from the sorting work in the past.

The result data 700 includes work time result data 710, personnel placement result data 720, and work sequence result data 730. The work time result data 710 is result data regarding the work time with respect to each process shown in FIG. 1. Specifically, for example, the work time result data 710 includes the process ID 611, the process name 612, and work time 713. The work time 713 indicates time taken to work in the process identified by the process ID 611 and the process name 612.

The personnel placement result data 720 is plan data regarding arrangement of the workers 101 with respect to each process shown in FIG. 1. Specifically, for example, the personnel placement plan data 620 includes the process ID 611, the process name 612, and a number of workers per hour 723. The number of workers per hour 723 indicates the planned number of the workers who worked in each process per unit time (e.g., per hour).

The work sequence result data 730 indicates the work sequence of the commodity actually performed. Specifically, for example, the work sequence result data 730 includes a sequential order 731, the commodity code 403, and a count 732. The sequential order 731 indicates an ascending numerical order in the work order of the commodity. The count 732 indicates the count of the commodities identified by the commodity code 403 having been processed in the sequential order 631. The work sequence result data 730 is present, for example, with respect to each process and each day.

### Example Perturbation Generation

FIG. 8 is an explanatory diagram showing an example perturbation generation by the perturbation generation unit 320. The perturbation generation unit 320 acquires the work sequence plan data 630 and the work sequence result data 730, and performs the perturbation trend learning 221 with respect to each process. Specifically, for example, the perturbation generation unit 320 compares the work sequence in the work sequence plan data 630 and the work sequence in the work sequence result data 730 in commodity pairs of a plurality of same positions in the sequential order. The plurality of same positions in the sequential order may be successive positions in the sequential order (Nth and N+1th) or may be discrete positions in the sequential order (e.g., Nth and N+2th) as long as the work sequence plan data 630 and the work sequence result data 730 are in the same positions in the sequential order. By way of example, FIG. 8 shows the successive positions in the sequential order (Nth and N+1th).

In a remarkable point 801, pairs of the fourth and fifth commodities are compared. Because the pairs of the fourth and fifth commodities are “B, C” in both the work sequence plan data 630 and the work sequence result data 730, it is indicated that the fourth and fifth commodities are processed in the order as in the work sequence plan data 630.

In a remarkable point 802, pairs of the tenth and eleventh commodities are compared. The pair of the tenth and eleventh commodities is “E, F” in the work sequence plan data 630, while the pair of the tenth and eleventh commodities is “F, E” in the work sequence result data 730. Accordingly, it is indicated that the sequential order is altered from the work sequence plan data 630 for the tenth and eleventh commodities.

The perturbation generation unit 320 compares the work sequence plan data 630 and the work sequence result data 730 while changing the work sequence result data 730 with respect to each process, and calculates a probability that each pair of the Nth and N+1th commodities is processed in the expected order (probability of being processed as specified by the work sequence plan data 630). The occurrence probability represents the perturbation trend data 322.

Although the occurrence probability is supposed herein to be the probability of being processed as specified by the work sequence plan data 630, the occurrence probability may be a probability that each pair of the Nth and N+1th commodities is not processed in the expected order (probability of not being processed as specified by the work sequence plan data 630). The perturbation trend data 322 is generated with respect to each process. Moreover, although the perturbation trend data 322 is supposed herein to be the occurrence probability of a combination of two positions in the sequential order (Nth and N+1th in FIG. 8), it may be the occurrence probability of the combination of three or more positions in the sequential order (e.g., Nth, N+1th, and N+2th).

### Example Evaluation

FIG. 9 is an explanatory diagram showing an example evaluation by the evaluation unit 330. First, a learning data set 900 is prepared. The learning data set 900 may be generated by the evaluation unit 330 or externally provided.

The learning data set 900 is generated on the basis of the order list group 310, the commodity master 311, and the result data group. The learning data set 900 includes date 901, work time 902, a number of workers 903, a count 904, and M (M is an integer of 1 or more) order ratios per category CR1 to CRM. When the order ratios per category CR1 to CRM are not distinguished, they are simply referred to as an order ratio per category CR.

The data 901 indicates year, month, and day in the order list 352 of the order list group 310 and the result data 700 of the result data group 313.

The work time 902 indicates the total of the work time 713 of each process in the result data 700 of the data 901. The number of workers 903 indicates the total of the number of workers per hour 723 of each process in the result data 700 of the data 901. The count 904 indicates the count 732 of each process in the result data 700 of the data 901.

The order ratios per category CR1 to CRM is generated, for example, with respect to each partial work sequence generated by dividing a work sequence of the day by M. The order ratio per category CR is a set of order ratios c1 to cn (n is an integer of 1 or more) assuming the number of the categories 502 of the commodities identified by the commodity code 403 and the commodity name 501 as n.

The total of the order ratios c1 to cn is 1. An order ratio ci (i is an integer that satisfies 1≤i≤n) indicates the probability that an i-th category 502 is ordered from among all the categories 502 in the partial work sequence generated by dividing the daily work sequence of the date 901 by M. This allows for converting the work sequence into a fixed length of feature quantity divided by M.

Among the learning data set, the order ratios per category CR1 to CRM are learning data input to the neural network. Correct answer data includes an evaluation value in accordance with the work time (which may be the work time itself or a reciprocal of the work time) or the evaluation value in accordance with the number of workers (which may be the number of workers or a reciprocal of the number of workers). The evaluation unit 330 performs the KPI learning 231 using the learning data and the correct answer data, and generates the KPI estimation model 232 in a case of working on the work sequence corresponding to the order ratios per category CR1 to CRM in all the processes.

### Example Work Sequence Generation Model Learning

FIG. 10 is an explanatory diagram showing an example work sequence model learning by the work sequence generation model learning unit 340. The work sequence generation model learning unit 340 generates the robust work sequence generation model 341 in the following steps using the work sequence plan data 630 as the input.

The work sequence generation model learning unit 340 maps the work sequence in the work sequence plan data 630 from a solution space 1000 to a feasible solution space 1001 (Step S1001). At Step S1001, an attention mechanism, which is the existing technique, is applied.

Next, the work sequence generation model learning unit 340 searches for an optimal solution for the work sequence in the work sequence plan data 630 by applying an existing technique such as a genetic algorithm (Step S1002). Specifically, for example, the work sequence generation model learning unit 340 perturbates the work sequence in the work sequence plan data 630 using the perturbation trend data 322, and calculates the KPI of the perturbated work sequence using the KPI estimation model 232.

The work sequence generation model learning unit 340 then updates the weight parameter of the neural network on the basis of the difference between the calculated KPI and the target KPI regarding the work sequence plan data 630, and generates the work sequence generation model 341 (Step S1003). The work sequence generation model learning unit 340 performs Steps S1102 and S1003 repeatedly, for example, until the difference between the calculated KPI and the target KPI is within the allowable range.

In this manner, according to the first embodiment, it is possible to provide a work sequence 353 capable of suppressing reduction of the KPI within the allowable range even if the sequential order is changed during work in each process.

### Second Embodiment

Now, a second embodiment is described. The work sequence generation apparatus according to the first embodiment perturbates the work sequence using the work sequence generation model and generates the work sequence with reduction of the KPI suppressed. In contrast, the work sequence generation apparatus according to the second embodiment perturbates the work sequence not using the work sequence generation model but by simulation, and generates the work sequence with reduction of the KPI suppressed. It should be noted that, in the second embodiment, because description focuses on the difference from the first embodiment, the same configurations are denoted with the same reference numerals as in the first embodiment, and the description thereof is omitted.

### Example Functional Configuration of Work Sequence Generation Apparatus

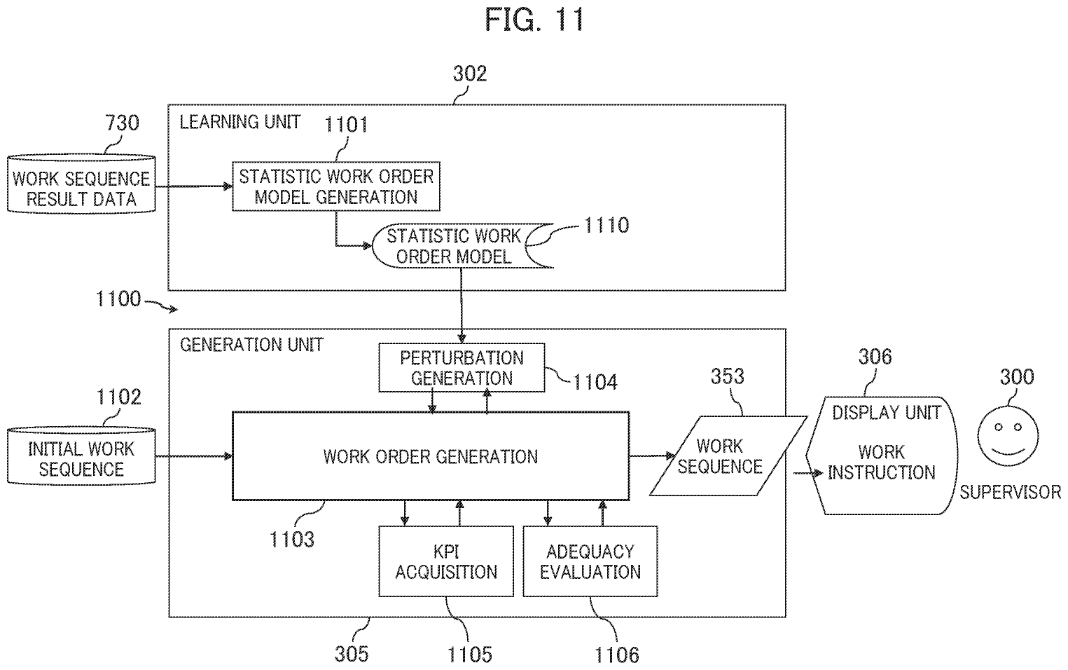

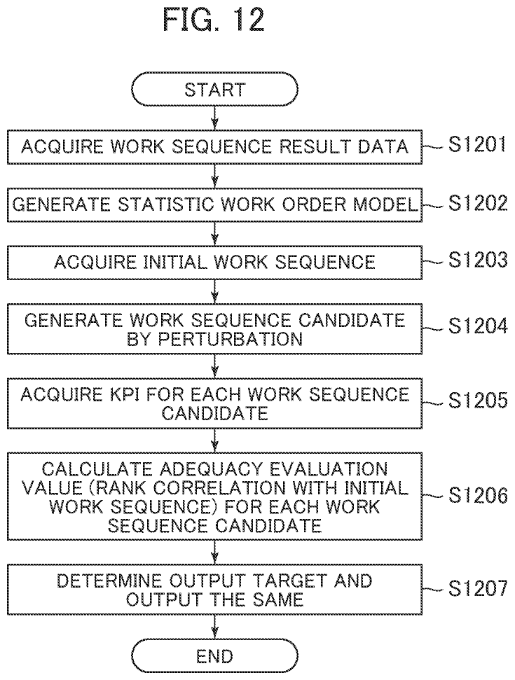

FIG. 11 is a block diagram showing an example functional configuration of a work sequence generation apparatus according to the second embodiment. FIG. 12 is a flowchart showing an example work sequence generation procedure by the work sequence generation apparatus according to the second embodiment. The work sequence generation apparatus 1100 includes the learning unit 302, the learning unit 302, and the generation unit 305105.

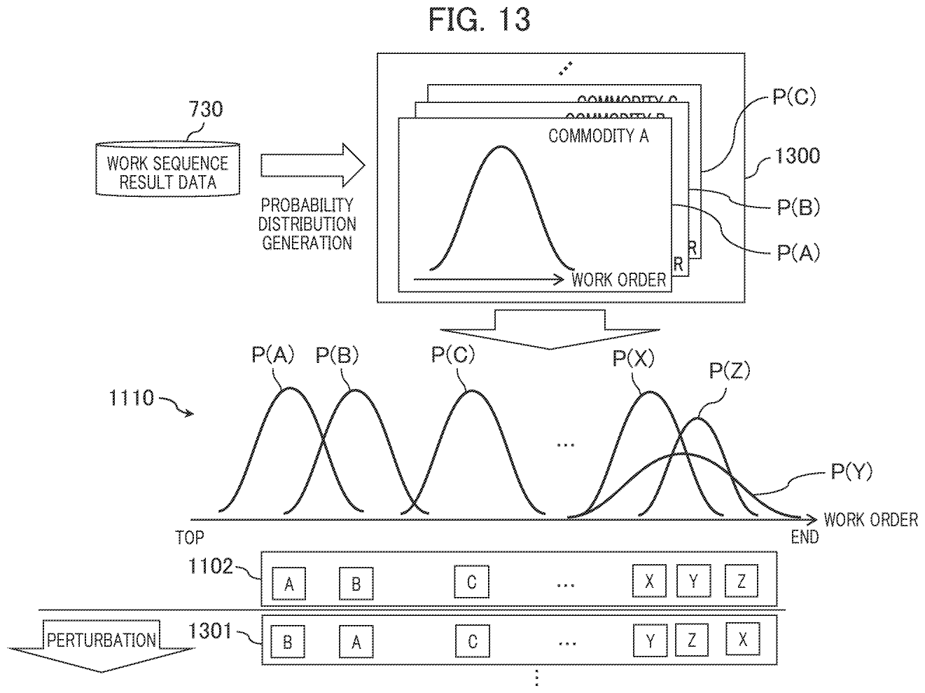

When the learning unit 302 acquires the work sequence result data 730 (Step S1201), the learning unit 302 generates a statistic work order model 1110 by statistic work order model generation 1101 (Step S1202). The statistic work order model generation 1101 and the statistic work order model 1110 will be described later with reference to FIG. 13. It should be noted that the work sequence generation apparatus 1100 may include the generated statistic work order model 1110 instead of the learning unit 302.

The generation unit 305 performs perturbation generation 1104, KPI acquisition 1105, and adequacy evaluation 1106 while performing the statistic work order model generation 1101. Specifically, for example, when the generation unit 305 acquires an initial work sequence 1102 (Step S1203), the generation unit 305 performs the perturbation generation 1104 and generates one or more work sequence candidates by perturbating the initial work sequence (Step S1204). The initial work sequence 1102 may be, for example, the work sequence plan data 630 or the work sequence result data 730. Details of the perturbation generation 1104 will be described later with reference to FIG. 13.

Next, the generation unit 305 acquires the KPI of each work sequence candidate by the KPI acquisition 1105 (Step S1205). The KPI acquisition 1105 may be, for example, a process of calculating the KPI by a known technique. Moreover, as shown in FIG. 9 of the first embodiment, the KPI acquisition 1105 may be a process of calculating the KPI using the KPI estimation model generated by the evaluation unit 330. Furthermore, the KPI acquisition 1105 may receive the KPI calculated by an external computer as a result of transmitting the work sequence candidate to the external computer communicable with the work sequence generation apparatus 1100.

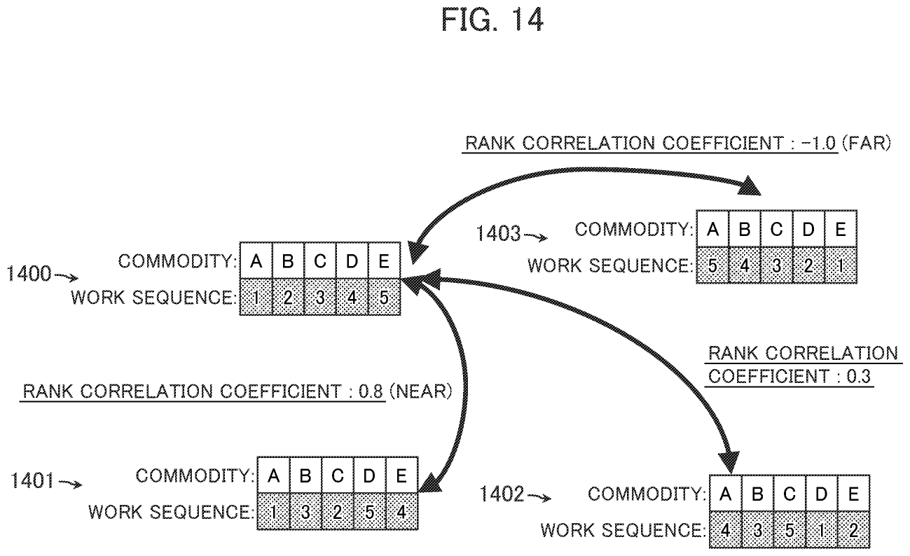

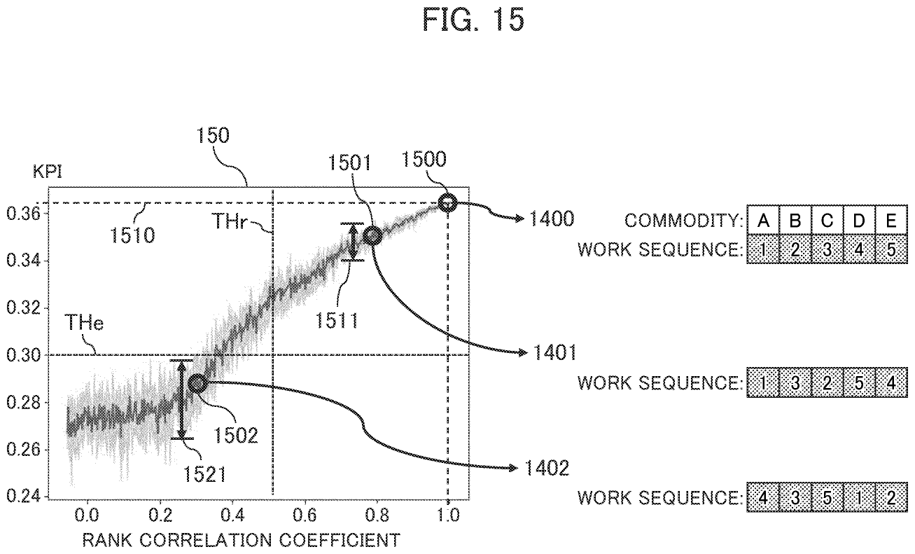

Next, the generation unit 305 performs the adequacy evaluation 1106 on each of the work sequence candidates (Step S1206). The adequacy evaluation 1106 is, for example, a process of deriving the rank correlation coefficient between the initial work sequence 1102 and each of the work sequence candidates and evaluating the adequacy of each of the work sequence candidate. Details of the adequacy evaluation 1106 will be described later with reference to FIGS. 14 and 15.

The generation unit 305 then outputs an evaluation result of the adequacy evaluation 1106 (Step S1207). The output evaluation result is, for example, displayed on the display unit 306.

### Example Statistic Work Order Model Generation and Example Perturbation Generation

FIG. 13 is an explanatory diagram showing an example statistic work order model generation and an example perturbation generation. The learning unit 302 generates a probability distribution group 1300 of the work orders of the commodity included in the work sequence result data 730. The probability distribution group 1300 of the work orders of the commodity is a set of probability distributions P(A), P(B), P(C), . . . of the work order of the commodity. When the probability distributions P(A), P(B), P(C), . . . of the work order of the commodity are not distinguished, they are simply referred to as a probability distribution P of the work order of the commodity. The probability distribution P of the work order of the commodity is a probability distribution indicating which work sequence the commodity statistically tends to take.

For the probability distribution, various distributions including a normal distribution can be contemplated, and the probability distribution can also express the complicated statistic work order model 1110 by setting a parameter. The user can achieve generation of a likely perturbation simply by setting the parameter on the basis of knowledge.

The learning unit 302 may read the generated probability distribution group 1300 of the work order of the commodity stored in the storage device. Moreover, the learning unit 302 may acquire the probability distribution group 1300 of the work order of the commodity from the external computer communicable with the work sequence generation apparatus 1100. The learning unit 302 generates the statistic work order model 1110 including the probability distribution group 1300 of the work order of the commodity arranged in the work sequence.

The generation unit 305 generates the initial work sequence 1102 from the statistic work order model 1110. Although each of the commodities A to Z appear once in the initial work sequence 1102 for simplifying the description, there may be a commodity that appears multiple times.

Next, the generation unit 305 perturbates the initial work sequence 1102 by the perturbation generation 1104 and generates a work sequence candidate 1301. Specifically, for example, the generation unit 305 extracts the sequential order from the statistic work order model 1110 with respect to each commodity so as to be different from the initial work sequence 1102. That is, the sequence of the commodities A to Z may be altered. In this manner, the generation unit 305 can intentionally change the initial work sequence 1102 by the perturbation generation 1104.

Although the Thurston type is described as an example of perturbation in FIG. 13, the perturbation type is not limited to the Thurston type but may be the paired comparison type, the distance-based type, or the multistage type.

### Example Adequacy Evaluation

Next, the adequacy evaluation 1106 is described with reference to FIGS. 14 and 15.

FIG. 14 is an explanatory diagram showing an example calculation of the rank correlation by the adequacy evaluation 1106. If similarity of the work sequence in the work field is well expressed, close positions in the sequential orders are more easily switched between two work sequences and remote positions in the sequential orders are rather hardly switched. As a scale to measure the similarity of the work sequences, a rank vector (a vector with a target commodity is fixed and work sequences are arranged as elements) is used for the work sequence, which is regarded as a regular vector to define a distance. In this case, a Spearman rank correlation coefficient (a value representing a Spearman distance normalized by the number of elements) is applied. The rank correlation coefficient takes a value in a range from −1.0 to 1.0, the larger value of which means the two work sequences are more similar.

In FIG. 14, it is assumed that the rank correlation coefficient between an initial work sequence 1400 indicative of the work sequence of the commodities A to E and a perturbated work sequence candidate 1401 is 0.8, the rank correlation coefficient between the initial work sequence 1400 and a perturbated work sequence candidate 1402 is 0.3, and the rank correlation coefficient between the initial work sequence 1400 and a perturbated work sequence candidate 1403 is −1.0.

FIG. 15 is an explanatory diagram showing an example adequacy evaluation by the adequacy evaluation 1106. In an evaluation result graph 150, the horizontal axis indicates the rank correlation coefficient, and the vertical axis indicates the KPI acquired by the KPI acquisition 1105. The KPI on the vertical axis is the KPI of the work sequence candidate to be compared with the initial work sequence 1102. It is assumed that the higher the KPI is, the higher the evaluation is (for example, the work time is shorter, or the number of workers is smaller).

A point 1500 is an intersection point of the rank correlation coefficient between the rank correlation coefficients 1400 and the KPI of the rank correlation coefficient 1400 plotted on the evaluation result graph 150. Since it is a rank correlation between the initial work sequences 1400, the rank correlation coefficient is 1.0. Moreover, a range from the KPI (denoted by a reference numeral 1510) to a threshold THe is the allowable range for the KPI. The threshold THe is a lower limit value of the KPI with respect to the KPI of the initial work sequence 1400. That is, if the KPI of the work sequence candidate is equal to or higher than the threshold THe, the work sequence candidate is regarded as the robust work sequence with respect to the initial work sequence 1400 and output to the display unit 306.

A point 1501 is an intersection point of the rank correlation coefficient between the initial work sequence 1400 and the work sequence candidate 1401 (=0.8) and the KPI of the work sequence candidate 1401 that is equal to or higher than the threshold THe plotted on the evaluation result graph 150. An amplitude 1511 of the point 1501 in a direction of the vertical axis indicates distribution of other work sequence candidates having the same rank correlation coefficient. The larger the number of the other work sequence candidates having the same rank correlation coefficient are, the more the robustness is improved.

Because the KPIs of the other work sequence candidates in the amplitude 1511 are equal to the threshold THe and thus none of the KPIs becomes lower than the threshold THe even if the work sequence candidate 1401 is provided to the work field and changed to the other work sequence candidate, the work sequence candidate 1401 is evaluated to be robust. However, in a case in which the number of the other work sequence candidates in the amplitude 1511 is smaller than a predetermined number, the work sequence candidate 1401 is evaluated to be not robust.

A point 1502 is an intersection point of the rank correlation coefficient between the initial work sequence 1400 and the work sequence candidate 1402 (=0.3) and the KPI of the work sequence candidate 1402 that is lower than the threshold THe plotted on the evaluation result graph 150. An amplitude 1521 of the point 1502 in the vertical axis indicates distribution of other work sequence candidates having the same rank correlation coefficient.

The KPI of the work sequence candidate 1402 is not adopted because it is lower than the threshold THe. Even if the threshold THe is 0.28, the other work sequence candidates in the amplitude 1521 of the work sequence candidate 1402 include the work sequence candidate having the KPI lower than the threshold THe. Therefore, even when the threshold THe is 0.28, the work sequence candidate 1402 is evaluated to be not robust.

Moreover, in FIG. 15, the generation unit 305 may exclude the work sequence candidate 1402 having the rank correlation coefficient lower than a threshold THr. This is because the work sequence candidate 1402 having the rank correlation coefficient lower than a threshold THr is hardly generated when the sequential order is changed during an actual work. The thresholds THe, THr are user-configurable parameters.

### Example Screen

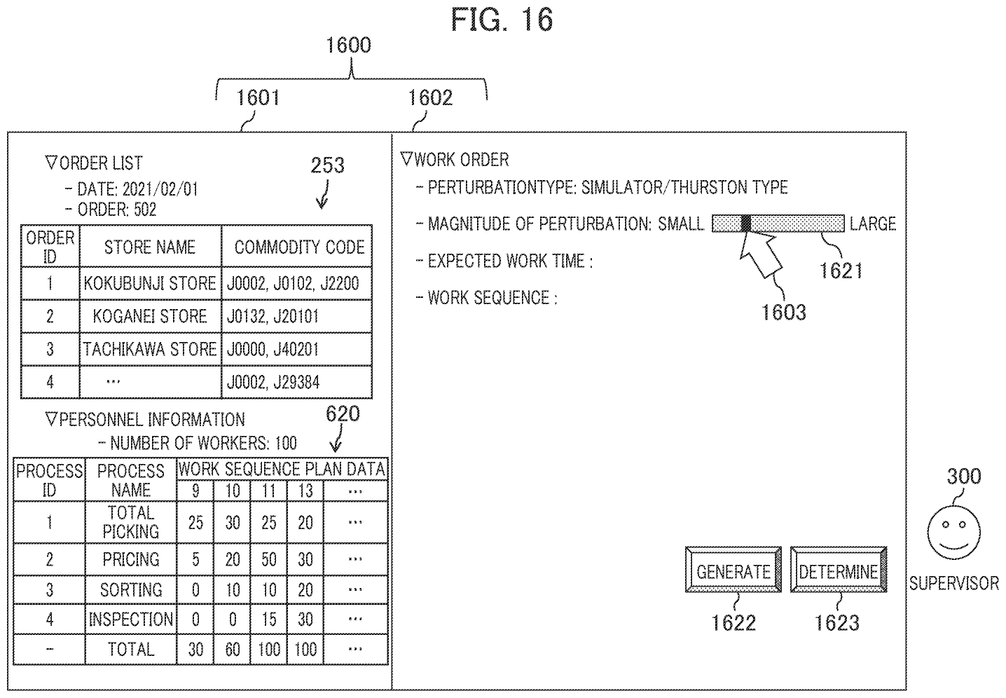

FIG. 16 is an explanatory diagram showing a first example display screen of the work sequence generation apparatus. A display screen 1600 is displayed on the display unit 306. Displayed in a first display area 1601 are the order list 352 and the personnel placement plan data 620 corresponding to the work sequence plan data 630 to be the initial work sequence 1102.

Displayed in a second display area 1602 is information regarding the work order. Perturbation type indicates a type of perturbation. A graphical user interface in the second display area 1602 allows the user to select any one of the Thurston type, the paired comparison type, the distance-based type, and the multistage type. FIG. 16 shows a state in which the Thurston type is selected.

A magnitude of perturbation represents a frequency of switching the sequential order between the initial work sequence 1102 and the work sequence candidate 1301. The user can adjust the magnitude of perturbation by manipulating slider 1621 with a cursor 1603. The frequency corresponding to the position of the cursor 1603 indicates difference of commodities between the initial work sequence 1102 and the work sequence candidate 1301 in the same position in the sequential order. This allows for suppressing excessive change of the sequential order and outputting a practical work sequence candidate 1301.

The expected work time means the work time estimated by a generated work sequence 253. For example, the work sequence generation apparatus 1100 calculates the order ratios per category CR1 to CRM from the generated work sequence 253 and calculates the KPI regarding the work time by inputting the order ratios per category CR1 to CRM to the KPI estimation model 232. The work sequence generation apparatus 1100 outputs the KPI regarding the work time as the expected work time if it is the work time, and calculates the reciprocal of the KPI regarding the work time as the expected work time if the KPI regarding the work time is the reciprocal of the work time.

Moreover, although not shown, on the display screen 1600, the lower limit values of other work sequence candidates having the same rank correlation coefficient may be set by a user operation.

A generation button 1622 is a graphical user interface for the generation unit 305 to start a process on the basis of the perturbation type and the magnitude of perturbation by pressing it. A determination button 1623 is a graphical user interface for instructing the generated work sequence 253 to the work field by pressing it.

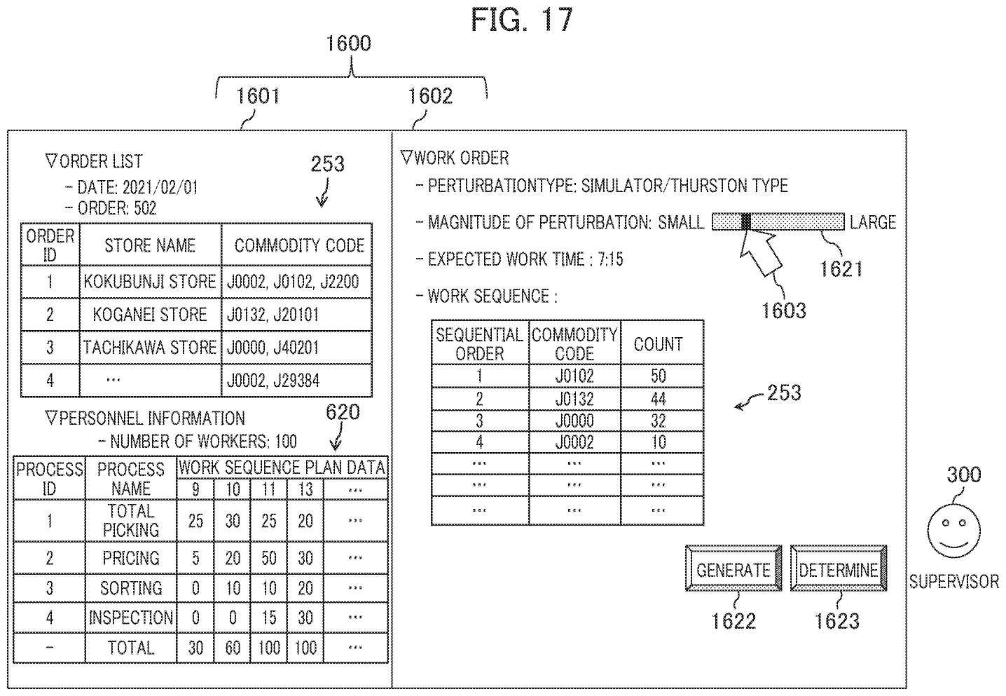

FIG. 17 is an explanatory diagram showing a second example display screen of the work sequence generation apparatus. FIG. 17 shows an example display screen in a case in which the generation button 1622 is pressed and the work sequence 253 is generated by the generation unit 305. Displayed in the second display area is the work sequence 253 generated by the generation unit 305. When the determination button 1623 is pressed in this state, the work sequence 253 is transmitted to a computer in the work field. Accordingly, the workers in the work field shall work in accordance with the work sequence 253.

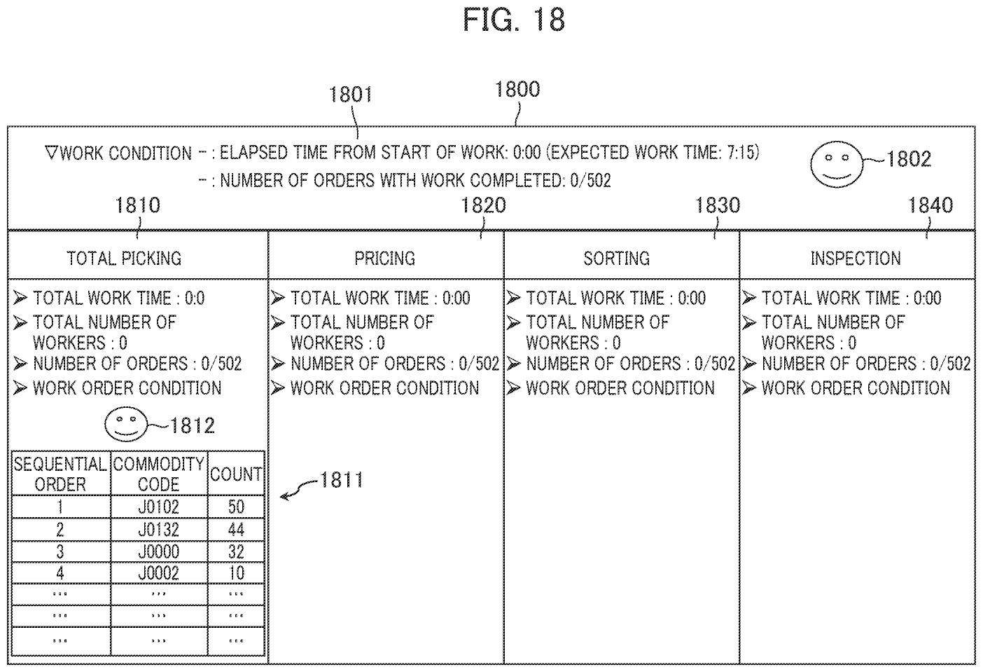

FIG. 18 is an explanatory diagram showing a first example progress screen of the work sequence generation apparatus. FIG. 18 shows a display example of a progress screen 1800 at the start of the work. The progress screen 1800 is a screen that presents progress information of the work, which is displayed on the display unit 306. The progress screen 1800 includes an overall progress status display area 1801, a total picking progress status display area 1810, a pricing progress status display area 1820, a sorting progress status display area 1830, and an inspection progress status display area 1840.

The overall progress status display area 1801 displays a progress status of all the processes. Specifically, for example, elapsed time from the start of work, expected work time, and the number of orders that have been completed are displayed. Moreover, an icon 1802 indicates the progress status by the facial expression.

The total picking progress status display area 1810, the pricing progress status display area 1820, the sorting progress status display area 1830, and the inspection progress status display area 1840 display the total work time, the total number of workers, the number of orders, and the work order condition. The total work time indicates the work time required by the process. The total number of workers indicates the number of workers required by the process. The number of orders indicates the number of orders processed in the process. The work order condition indicates the status of the work order in the process. The total work time, the total number of workers, and the number of orders are acquired from a system that manages the work field in which each process is performed.

It should be noted that a work sequence 1811 and an icon 1812 are displayed in the total picking progress status display area 1810 as the work order condition. The work sequence 1811 is the work sequence 253 regarding the total picking generated by the work sequence generation apparatus. The icon 1812 indicates the progress status of the total picking by the facial expression.

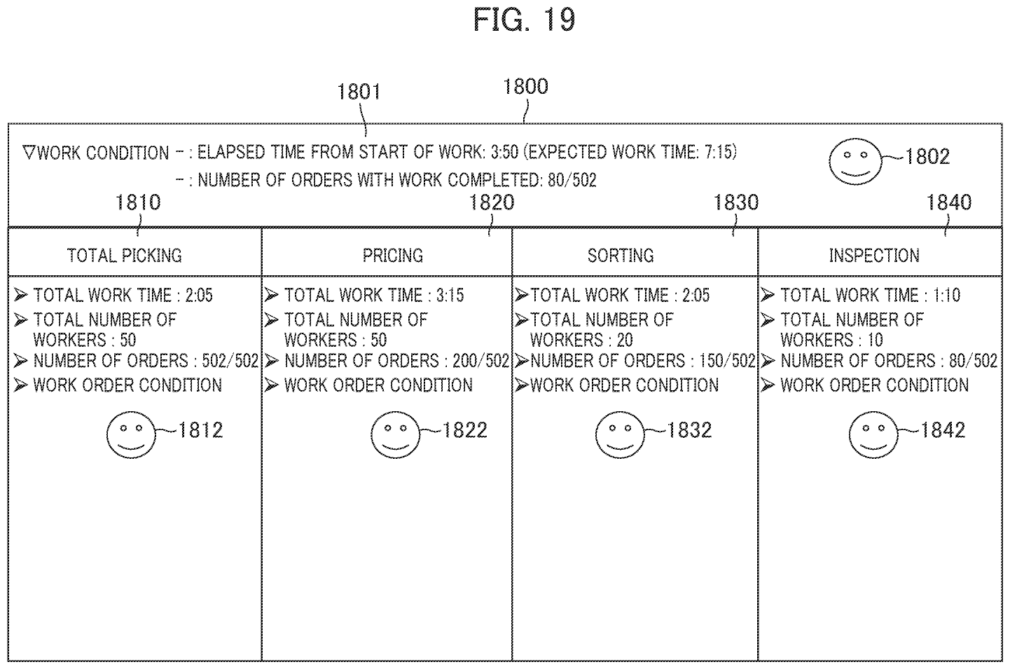

FIG. 19 is an explanatory diagram showing a second example progress screen of the work sequence generation apparatus. FIG. 19 shows a display example of the progress screen 1800 during work. Since the works of pricing, sorting, and inspection started, these works are displayed by icons 1822, 1832, and 1842, respectively.

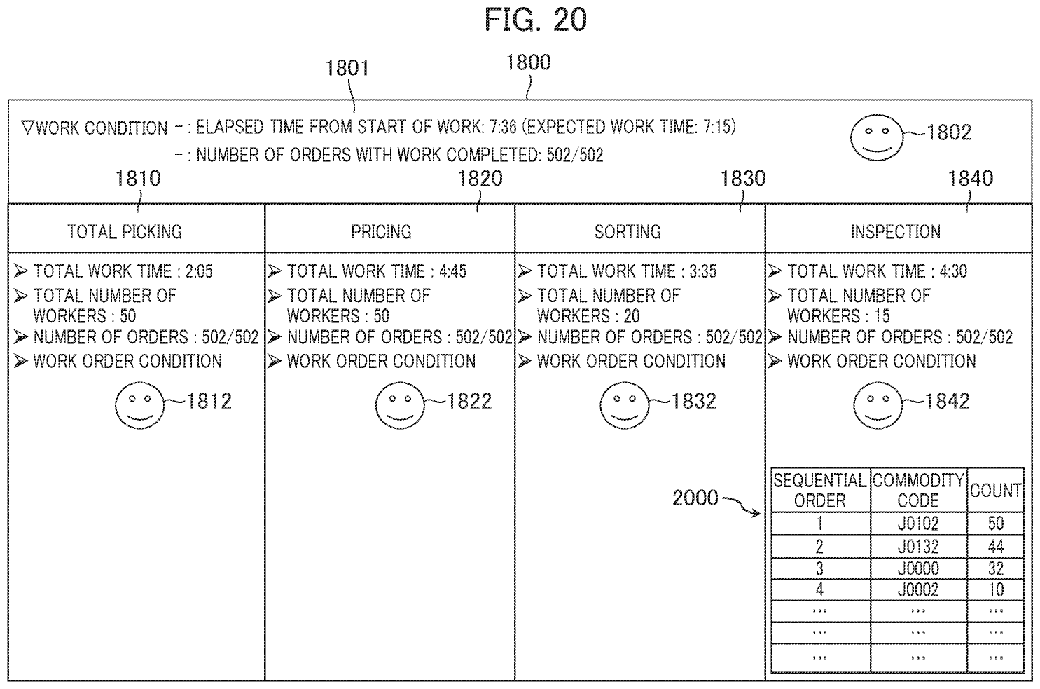

FIG. 20 is an explanatory diagram showing a third example progress screen of the work sequence generation apparatus. FIG. 20 shows a display example of the progress screen 1800 at the end of the work. The inspection progress status display area 1840 displays a work sequence 2000. The work sequence 2000 is the work sequence 253 regarding inspection generated by the work sequence generation apparatus.

It should be noted that, in FIGS. 18 to 20, for each of the icons 1802, 1812, 1822, 1832, and 1842, a smiling facial expression indicates that the work is in progress, and a dissatisfied facial expression indicates that the work is delayed. Moreover, the example screens shown in FIGS. 16 to 20 are similar in the first embodiment. However, when applied to the first embodiment, selection of the perturbation type is not present.

In this manner, the second embodiment can provide a work sequence 252 capable of suppressing reduction of the KPI within the allowable range even if the sequential order is changed during work in each process.

Moreover, the work sequence generation apparatus 200, 1100 according to the first embodiment and the second embodiment described above may be configured as described below in (1) to (12).

(1) The work sequence generation apparatus 200 includes the processor 201 that executes a program and the storage device 202 that stores therein the program, and generates a work sequence specifying an order of working on a processing object group (e.g., a commodity group). The processor 201 performs a perturbation process of generating a second work sequence by perturbating a first work sequence (e.g., work sequence result data 730), and a learning process of generating a learning model (the work sequence generation model 341) for generating a specific work sequence so that a difference from an evaluation value regarding a work in an input work sequence (e.g., the work sequence plan data 630) is within an allowable range by learning that a difference between a first evaluation value regarding a work in the first work sequence and a second evaluation value regarding a work in a second work sequence generated in the perturbation process should be within the allowable range.

In this manner, the machine learning allows for evaluating a work order by perturbating it while searching, and thereby searching for a robust and optimal work order.

(2) In the work sequence generation apparatus 200 according to (1) described above, in the perturbation process, the processor 201 generates the second work sequence by changing a combination of a plurality of processing objects in a plurality of positions in the first work sequence on the basis of the perturbation trend data 322 specifying occurrence probability regarding the combination of the plurality of processing objects in the plurality of positions in the sequential order.

This makes it possible to provide perturbation by the probability of which place in the sequential order is switched.

(3) In the work sequence generation apparatus 200 according to (2) described above, the processor 201 performs a first generation process of generating the perturbation trend data 322 on the basis of distinction between a combination of the plurality of processing objects in the plurality of positions in a planned work sequence planned before the work (e.g., the work sequence plan data 630) and the plurality of processing objects in the plurality of positions in a result work sequence in a case in which the work is performed in the planned work sequence (e.g., the work sequence result data 730), and, in the perturbation process, the processor 201 generates the second work sequence by changing a combination of the plurality of processing objects in the plurality of positions in the first work sequence on the basis of the perturbation trend data 322 generated in the first generation process.

This makes it possible to provide perturbation by the probability of which place is changed, the probability being acquired from the result of distinction between the work sequence plan data 630 and the work sequence result data 730 actually altered from the work sequence plan data 630.

(4) In the work sequence generation apparatus 200 according to (1) described above, in the learning process, the processor 201 calculates the first evaluation value by inputting the first work sequence to an evaluation value estimation model and calculates the second evaluation value by inputting the second evaluation value to the evaluation value estimation model using the evaluation value estimation model that calculates an evaluation value regarding a work in the input work sequence, and generates the learning model by learning that a difference between the first evaluation value and the second evaluation value should be within the allowable range.

This allows for generating the second work sequence with reduction of the evaluation value being suppressed within the allowable range.

(5) In the work sequence generation apparatus 200 according to (4) described above, the processor 201 performs a second generation process of generating the evaluation value estimation model (a KPI estimation model 332) by learning an evaluation value regarding the result work order as correct answer data using proportion data per category (the order ratio per category CR) generated by classifying each processing object in the processing object group in the result work sequence (the work sequence result data 730) into a predetermined number of categories 502 as the learning data, and in the learning process, the processor 201 generates the learning model using an evaluation value estimation model generated by the second generation process.

This allows for estimating the evaluation value with high accuracy and generating the learning model (the work sequence generation model 341).

(6) The work sequence generation apparatus 1100 includes the processor 201 that executes a program and the storage device 202 that stores therein the program, and generates a work sequence specifying an order of working on a processing object group. The processor 201 performs a perturbation process of generating a second work sequence (work sequence candidate 1301) by perturbating a first work sequence (initial work sequence 1102) (Step S1204), a calculation process of calculating a rank correlation coefficient between the first work sequence and the second work sequence (Step S1206), and a determination process of determining the second work sequence to be an output target on the basis of a comparison result between a lower-limit evaluation value THe based on a first evaluation value regarding a work in the first work sequence and a second evaluation value regarding a work in the second work sequence, and a number of third work sequences that is the rank correlation coefficient calculated in the calculation process (Step S1207).

In this manner, a simulation allows for evaluating a work order by perturbating it while searching, and thereby searching for a robust and optimal work order.

(7) In the work sequence generation apparatus 1100 according to (6) described above, in the determination process, when the second evaluation value is equal to or higher than the lower-limit evaluation value THe, the processor 201 determines the second work sequence to be an output target.

(8) In the work sequence generation apparatus 1100 according to (6) described above, in the determination process, when the number of the third work sequences is equal to or higher than a predetermined number, the processor 201 determines the second work sequence to be an output target.

This allows for covering a predetermined number of more of the altered work sequences.

(9) In the work sequence generation apparatus 1100 according to (8) described above, the processor 201 outputs a screen on which the predetermined number can be set in a displayable manner.

This allows the user to freely set the predetermined number.

(10) In the work sequence generation apparatus 1100 according to (6) described above, in the perturbation process, the processor 201 generates the second work sequence using a probability distribution group 1300 in which a sequential order of each processing object in the processing object group based on the result work sequence is generated.

This allows for generating a work sequence that is statistically easy to appear.

(11) In the work sequence generation apparatus 1100 according to (6) described above, in the perturbation process, the processor 201 generates the second work sequence on the basis of difference of the processing objects from the first work sequence in the same position in the sequential order.

This allows for increasing variations of the second work sequence (work sequence candidate 1301).

(12) In the work sequence generation apparatus 1100 according to (11) described above, the processor 201 outputs a screen on which an upper limit number for the different processing object can be set in the second work sequence in a displayable manner.

This allows the user to freely set the upper limit number for the different processing object.

It should be noted that the present invention is not limited to the above-described embodiments, and various modifications and equivalent configurations are included. For example, the above-described embodiments are described in detail for plainly explaining the present invention, and the invention is not necessarily limited to those including all the configurations described herein. Moreover, a part of a configuration in a certain embodiment may be replaced by a configuration of another embodiment. Furthermore, a configuration in a certain embodiment may be added to a configuration of another embodiment. Still further, a part of a configuration of each embodiment may be added to, deleted, or replaced by another configuration.

Moreover, some or all of the configurations, functions, processing units, processing measures, and the like described above may be embodied in hardware by designing them as an integrated circuit, for example, or may be embodied in software by the processor 201 interpreting and executing a program that embodies each function.

Information for embodying each function such as a program, a table, a file, and the like may be stored in a storage unit such as a memory, a hard disk, an SSD (Solid State Drive), and the like, or in a recording medium such as an IC (Integrated Circuit) card, an SD card, a DVD (Digital Versatile Disc), and the like.

Moreover, only control lines and information lines are shown that are believed to be necessary for explanation, and not necessarily all the control lines and information lines are shown that are required for implementation. Practically, it may be supposed that almost all the configurations are connected to one another.

### LIST OF REFERENCE SIGNS

200, 1100: Work sequence generation apparatus
302: Learning unit
305: Generation unit
306: Display unit
320: Perturbation generation unit
330: Evaluation unit
340: Work sequence generation model learning unit

1. A work sequence generation apparatus including a processor that executes a program and a storage device that stores therein the program, and generating a work sequence specifying an order of working on a processing object group,
wherein the processor performs
a perturbation process of generating a second work sequence by perturbating a first work sequence, and
a learning process of generating a learning model for generating a specific work sequence so that a difference from an evaluation value regarding a work in an input work sequence is within an allowable range by learning that a difference between a first evaluation value regarding a work in the first work sequence and a second evaluation value regarding a work in a second work sequence generated in the perturbation process should be within the allowable range.

2. The work sequence generation apparatus according to claim 1,
wherein, in the perturbation process, the processor generates the second work sequence by changing a combination of a plurality of processing objects in a plurality of positions in the first work sequence on the basis of the perturbation trend data specifying occurrence probability regarding the combination of the plurality of processing objects in the plurality of positions in the sequential order.

3. The work sequence generation apparatus according to claim 2,
wherein the processor
performs a first generation process of generating the perturbation trend data 322 on the basis of distinction between a combination of the plurality of processing objects in the plurality of positions in a planned work sequence planned before the work and the plurality of processing objects in the plurality of positions in a result work sequence in a case in which the work is performed in the planned work sequence, and
wherein, in the perturbation process, the processor generates the second work sequence by changing a combination of the plurality of processing objects in the plurality of positions in the first work sequence on the basis of the perturbation trend data generated in the first generation process.

4. The work sequence generation apparatus according to claim 1,
wherein, in the learning process, the processor calculates the first evaluation value by inputting the first work sequence to an evaluation value estimation model and calculates the second evaluation value by inputting the second evaluation value to the evaluation value estimation model using the evaluation value estimation model that calculates an evaluation value regarding a work in the input work sequence, and generates the learning model by learning that a difference between the first evaluation value and the second evaluation value should be within the allowable range.

5. The work sequence generation apparatus according to claim 4,
wherein the processor performs a second generation process of generating the evaluation value estimation model by learning an evaluation value regarding the result work order as correct answer data using proportion data per category generated by classifying each processing object in the processing object group in the result work sequence into a predetermined number of categories as the learning data, and
wherein, in the learning process, the processor generates the learning model using an evaluation value estimation model generated by the second generation process.

6. A work sequence generation apparatus including: a processor that executes a program; and a storage device that stores therein the program and generating a work sequence specifying an order of working on a processing object group,
wherein the processor performs
a perturbation process of generating a second work sequence by perturbating a first work sequence,
a calculation process of calculating a rank correlation coefficient between the first work sequence and the second work sequence, and
a determination process of determining the second work sequence to be an output target on the basis of a comparison result between a lower-limit evaluation value based on a first evaluation value regarding a work in the first work sequence and a second evaluation value regarding a work in the second work sequence, and a number of third work sequences that is the rank correlation coefficient calculated in the calculation process.

7. The work sequence generation apparatus according to claim 6,
wherein, in the determination process, when the second evaluation value is equal to or higher than the lower-limit evaluation value, the processor determines the second work sequence to be an output target.

8. The work sequence generation apparatus according to claim 6,
wherein, in the determination process, when the number of the third work sequences is equal to or higher than a predetermined number, the processor determines the second work sequence to be an output target.

9. The work sequence generation apparatus according to claim 8,
wherein the processor
outputs a screen on which the predetermined number can be set in a displayable manner.

10. The work sequence generation apparatus according to claim 6,
wherein, in the perturbation process, the processor generates the second work sequence using a probability distribution group in which a sequential order of each processing object in the processing object group based on the result work sequence is generated.

11. The work sequence generation apparatus according to claim 10,
wherein, in the perturbation process, the processor generates the second work sequence on the basis of difference of the processing objects from the first work sequence in the same position in the sequential order.

12. The work sequence generation apparatus according to claim 11,
wherein the processor
outputs a screen on which an upper limit number for the different processing object can be set in the second work sequence in a displayable manner.

13. A work sequence generation method performed by a work sequence generation apparatus including a processor that executes a program and a storage device that stores therein the program and generating a work sequence specifying an order of working on a processing object group,
wherein the processor performs
a perturbation process of generating a second work sequence by perturbating a first work sequence, and
a learning process of generating a learning model for generating a specific work sequence so that a difference from an evaluation value regarding a work in an input work sequence is within an allowable range by learning that a difference between a first evaluation value regarding a work in the first work sequence and a second evaluation value regarding a work in a second work sequence generated in the perturbation process should be within the allowable range.

14. A work sequence generation method performed by a work sequence generation apparatus including a processor that executes a program and a storage device that stores therein the program and generating a work sequence specifying an order of working on a processing object group,
wherein the processor performs
a perturbation process of generating a second work sequence by perturbating a first work sequence,
a calculation process of calculating a rank correlation coefficient between the first work sequence and the second work sequence, and
a determination process of determining the second work sequence to be an output target on the basis of a comparison result between a lower-limit evaluation value based on a first evaluation value regarding a work in the first work sequence and a second evaluation value regarding a work in the second work sequence, and a number of third work sequences that is the rank correlation coefficient calculated in the calculation process.
